(19) United States
(12) Patent Application Publication
(10) Pub. No.: US 2017/0076849 A1
(43) Pub. Date: Mar. 16, 2017

(54) Coupled Inductor and Power Converter

(71) Applicant: Huawei Technologies Co., Ltd., Shenzhen (CN)

(72) Inventors: Yanshen Hu, Shenzhen (CN); Yunfeng Liu, Shanghai (CN); Fei Ye, Shanghai (CN)

(21) Appl. No.: 15/358,573

(22) Filed: Nov. 22, 2016

Related U.S. Application Data
(63) Continuation of application No. PCT/CN2015/079222, filed on May 18, 2015.

(30) Foreign Application Priority Data
May 27, 2014 (CN) 201410228277.X

(51) Int. Cl. H01F 27/24; H02M 1/00

(52) U.S. Cl. CPC H01F 27/24; H02M 1/00; H02M 2001/0083

(57) ABSTRACT

A coupled inductor and a power converter includes a magnetic core and at least two windings. The magnetic core includes at least two magnetic cylinders and two opposite magnet yokes. The at least two magnetic cylinders are disposed between the two opposite magnet yokes, the at least two windings are respectively wound around the at least two magnetic cylinders, the at least two windings are in a one-to-one correspondence with the at least two magnetic cylinders, and the at least two windings do not extend out of the two opposite magnet yokes in at least one direction, where each direction of the at least one direction is a direction perpendicular to side faces of the two opposite magnet yokes.

### CROSS-REFERENCE TO RELATED APPLICATIONS

This application is a continuation of International Application No. PCT/CN2015/079222, filed on May 18, 2015, which claims priority to Chinese Patent Application No. 201410228277.X, filed on May 27, 2014, both of which are hereby incorporated by reference in their entireties.

### TECHNICAL FIELD

The present application relates to the field of power and electronics, and in particular, to a coupled inductor and a power converter.

### BACKGROUND

Currently, an interleaved parallel technology is applied more widely to field of power and electronics, and especially, a multi-level power converter using the interleaved parallel technology is applied more widely. Multiple power bridge arms that are included in the multi-level power converter using the interleaved parallel technology are coupled by using multiple windings or coils in a coupled inductor and run in an interleaved manner so that on and off frequencies of output can be improved and an output ripple current can be reduced. Because the coupled inductor can generate leakage inductance, if the coupled inductor is directly connected to a load, a filter inductor can be saved, thereby reducing costs and a system volume.

However, when a relatively high common mode current passes through the coupled inductor, a relatively strong leakage magnetic field exists in air, which may cause an eddy current loss in windings of the coupled inductor.

### SUMMARY

Embodiments of the present application provide a coupled inductor and a power converter, which can reduce an eddy current loss caused in windings of a coupled inductor.

According to a first aspect, a coupled inductor is provided, including a magnetic core and at least two windings, where the magnetic core includes at least two magnetic cylinders and two opposite magnet yokes. The at least two magnetic cylinders are disposed between the two opposite magnet yokes, the at least two windings are respectively wound around the at least two magnetic cylinders, the at least two windings are in a one-to-one correspondence with the at least two magnetic cylinders, and the at least two windings do not extend out of the two opposite magnet yokes in at least one direction, where each direction of the at least one direction is a direction perpendicular to axes of the at least two magnetic cylinders.

With reference to the first aspect, in a first possible implementation manner, the two opposite magnet yokes extend out of the at least two windings in the at least one direction.

With reference to the first possible implementation manner, in a second possible implementation manner, the two opposite magnet yokes extend out of the at least two windings in two opposite directions.

With reference to the first possible implementation manner, in a third possible implementation manner, the two opposite magnet yokes extend out of the at least two windings in four directions in which every two directions are opposite.

With reference to the first aspect or any one of the first to third possible implementation manners of the first aspect, in a fourth possible implementation manner, each magnet yoke of the two opposite magnet yokes includes an angle portion and the angle portion surrounds a part of each of the at least two windings.

With reference to the first aspect or any one of the first to fourth possible implementation manners of the first aspect, in a fifth possible implementation manner, each magnet yoke of the two opposite magnet yokes includes at least two first parts corresponding to the at least two magnetic cylinders and at least one second part between the at least two first parts and the at least two first parts each have a width greater than a width of the at least one second part.

With reference to the first aspect, in a sixth possible implementation manner, the at least two windings are aligned with the two opposite magnet yokes in at least one direction.

With reference to the sixth possible implementation manner, in a seventh possible implementation manner, the two opposite magnet yokes are aligned with the at least two windings in two opposite directions.

With reference to the sixth possible implementation manner, in an eighth possible implementation manner, the two opposite magnet yokes are aligned with the at least two windings in four directions in which every two directions are opposite.

With reference to the first aspect or any one of the foregoing possible implementation manners, in a ninth possible implementation manner, the at least two magnetic cylinders include two magnetic cylinders or three magnetic cylinders.

According to a second aspect, a power converter is provided, including at least two power bridge arms and the coupled inductor according to any one of the possible implementation manners of the first aspect, where the at least two power bridge arms are respectively connected to at least two windings of the coupled inductor.

According to the technical solutions in the embodiments of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor.

### BRIEF DESCRIPTION OF DRAWINGS

To describe the technical solutions in the embodiments of the present application more clearly, the following briefly describes the accompanying drawings required for describing the embodiments of the present application. The accompanying drawings in the following description show merely some embodiments of the present application, and a person of ordinary skill in the art may still derive other drawings from these accompanying drawings without creative efforts.

FIG. 1 is a sectional view of a structure of a common coupled inductor having three magnetic cylinders;

FIG. 2A is a schematic structural diagram of a coupled inductor according to an embodiment of the present application;

FIG. 2B is a sectional view along A-A of the coupled inductor shown in FIG. 2A;

FIG. 2C is a sectional view along B-B of the coupled inductor shown in FIG. 2A;

FIG. 2D is a sectional view along C-C of the coupled inductor shown in FIG. 2A;

FIG. 3A is a sectional view of a coupled inductor according to another embodiment of the present application;

FIG. 3B is another sectional view of a coupled inductor according to another embodiment of the present application;

FIG. 4 is a sectional view of a coupled inductor according to another embodiment of the present application;

FIG. 5A is a sectional view of a coupled inductor according to another embodiment of the present application;

FIG. 5B is another sectional view of a coupled inductor according to another embodiment of the present application;

FIG. 5C is still another sectional view of a coupled inductor according to another embodiment of the present application; and

FIG. 6 is a schematic structural diagram of a power converter according to an embodiment of the present application.

### DESCRIPTION OF EMBODIMENTS

The following clearly describes the technical solutions in the embodiments of the present application with reference to the accompanying drawings in the embodiments of the present application. The described embodiments are a part rather than all of the embodiments of the present application. All other embodiments obtained by a person of ordinary skill in the art based on the embodiments of the present application without creative efforts shall fall within the protection scope of the present application.

The embodiments of the present application are applied to a multi-level power converter using an interleaved parallel technology. In the embodiments of the present application, a level of an electrical level of the multi-level power converter is not limited. For example, the multi-level power converter may be a two-level power converter, a three-level power converter, a five-level power converter, or the like. In the embodiments of the present application, a type of the multi-level power converter is not limited either. For example, the multi-level power converter may be a diode-clamped multi-level power converter, a capacitor-clamped multi-level power converter, or the like.

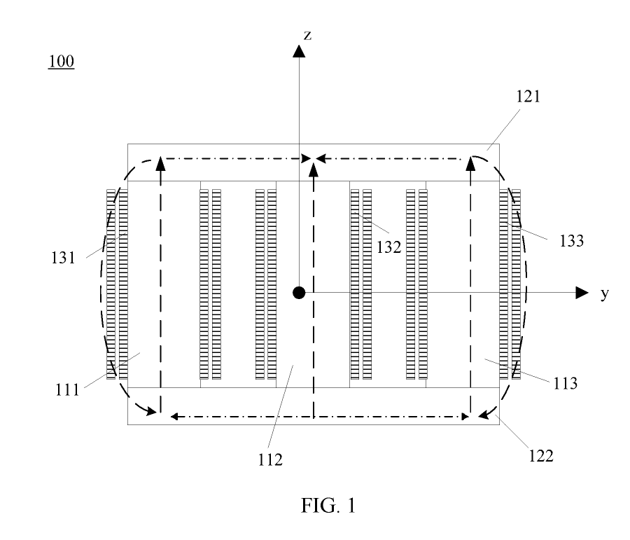

FIG. 1 is a sectional view of a structure of a common coupled inductor having three magnetic cylinders.

A sectional view of a structure of a common coupled inductor 100 having three magnetic cylinders along a y-z plane is shown in FIG. 1. The coupled inductor 100 includes magnetic cylinders 111, 112, and 113, an upper magnet yoke 121, a lower magnet yoke 122, and windings 131, 132, and 133 respectively wound around the magnetic cylinders 111, 112, and 113. Because a left side face of the winding 131 and a right side face of the winding 133 respectively extend out of two side faces, a left side face and a right side face of the upper magnet yoke 121 and the lower magnet yoke 122, when a relatively high common mode current passes through the coupled inductor 100, a leakage magnetic field that is generated by magnetic flux leakage in air cuts the windings 131 and 133 of the inductor, thereby causing an eddy current loss in the windings. When a load of a power converter at which the coupled inductor is located is relatively small, a power of the power converter is relatively low, but the eddy current loss accounts for a relatively large ratio of a total power, thereby leading to decreased efficiency of the power converter.

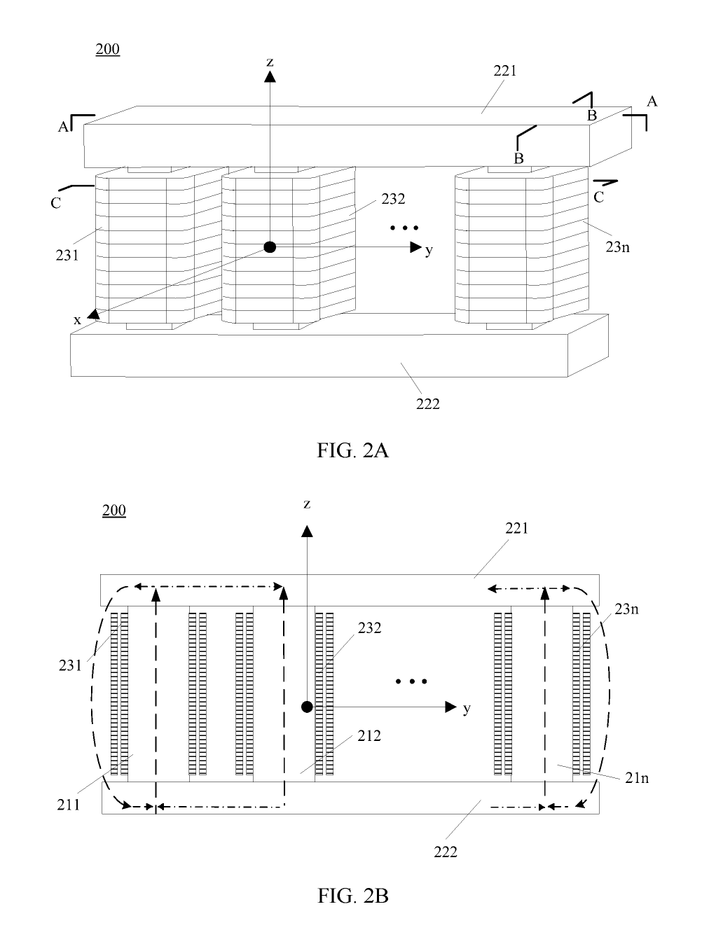

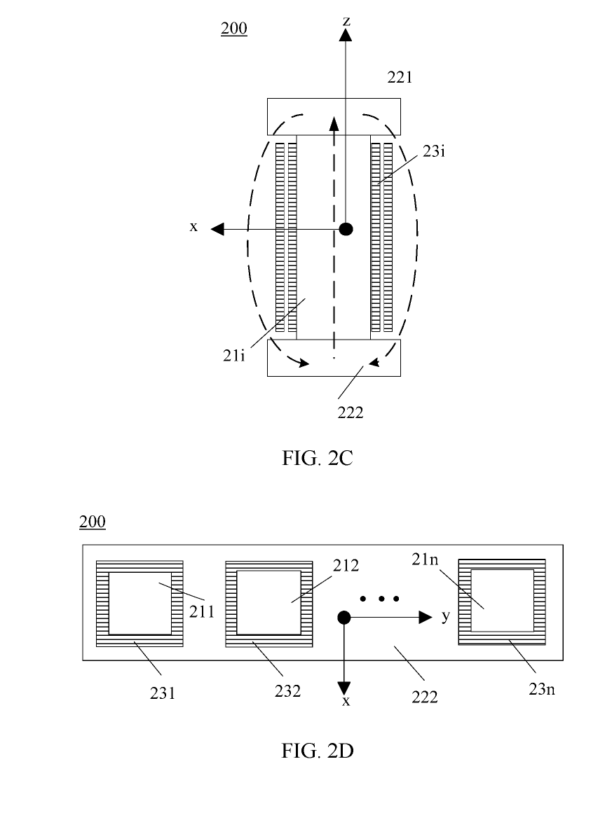

FIG. 2A is a schematic three-dimensional structural diagram of a coupled inductor 200 according to an embodiment of the present application.

A coupled inductor 200 shown in FIG. 2A and FIG. 2B includes a magnetic core and at least two windings. The magnetic core includes at least two magnetic cylinders 211, 212, . . . , and 21n and two opposite magnet yokes 221 and 222. The at least two magnetic cylinders 241, 242, . . . , and 24n are disposed between the two opposite magnet yokes 221 and 222, and at least two windings 231, 232, . . . , and 23n are respectively wound around the at least two magnetic cylinders 211, 212, . . . , and 21n. The at least two windings 231, 232, . . . , and 23n are in a one-to-one correspondence with the at least two magnetic cylinders 211, 212, . . . , and 21n. The at least two windings 231, 232, . . . , and 23n do not extend out of the two opposite magnet yokes 221 and 222 in at least one direction. Each direction of the at least one direction is a direction perpendicular to axes of the at least two magnetic cylinders.

According to this embodiment of the present application, the at least one direction may include one or more of an x direction, a y direction, a reverse direction of the x direction, or a reverse direction of the y direction. Side faces of the two opposite magnet yokes include side faces perpendicular to the x direction, the y direction, the reverse direction of the x direction, and the reverse direction of the y direction. A z direction is a direction parallel to the axes of the magnetic cylinders, and any two directions of the x direction, the y direction, and the z direction are perpendicular to each other. In other words, the side faces of the at least two windings may not extend out of the side faces of the two opposite magnet yokes in one or more directions of the x direction, the y direction, the reverse direction of the x direction, or the reverse direction of the y direction, or the side faces of the at least two windings fall within a coverage of the two magnet yokes.

For example, in the x direction, a front side face of each winding of the at least two windings 231, 232, . . . , and 23n may not extend out of front side faces of the upper magnet yoke 221 and the lower magnet yoke 222. Alternatively, in the reverse direction of the x direction, a rear side face of each winding of the at least two windings 231, 232, . . . , and 23n may not extend out of rear side faces of the upper magnet yoke 221 and the lower magnet yoke 222. In the y direction, a right side face of each winding of the at least two windings 231, 232, . . . , and 23n may not extend out of right side faces of the upper magnet yoke 221 and the lower magnet yoke 222, and in the reverse direction of the y direction, a left side face of the winding 231 may not extend out of left side faces of the upper magnet yoke 221 and the lower magnet yoke 222.

For another example, in the y direction, right side faces of the upper magnet yoke 221 and the lower magnet yoke 222 may extend out of a right side face of the winding 23n, and in the reverse direction of the y direction, left side faces of the upper magnet yoke 221 and the lower magnet yoke 222 may be aligned with a left side face of the winding 231.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be improved.

In the embodiment in FIGS. 2A-2D, a description is provided by using an example in which the coupled inductor 200 includes three or more magnetic cylinders. The at least two magnetic cylinders may also include two magnetic cylinders.

For ease of description, FIG. 2 shows a part of a structure of the coupled inductor 200, and the technical solution of this embodiment of the present application is described in detail by using the part of the structure as an example. However, this embodiment of the present application is not limited to this.

Optionally, according to an embodiment of the present application, the two opposite magnet yokes extend out of the at least two windings in the at least one direction. In other words, the side faces of the two opposite magnet yokes extend out of the side faces of the at least two windings in one or more of the x direction, the y direction, the reverse direction of the x direction, or the reverse direction of the y direction.

For example, in the y direction, the right side faces of the upper magnet yoke 221 and the lower magnet yoke 222 may extend out of the right side face of the winding 23n. Alternatively, in the reverse direction of the y direction, the left side faces of the upper magnet yoke 221 and the lower magnet yoke 222 may extend out of the left side face of the winding 231, which can reduce cutting of the windings by a leakage magnetic field that is generated by magnetic flux leakage in air, thereby reducing an eddy current loss in the windings.

For another example, in the y direction, the right side faces of the upper magnet yoke 221 and the lower magnet yoke 222 may extend out of the right side face of the winding 23n, and in the x direction, the front side faces of the upper magnet yoke 221 and the lower magnet yoke 222 may extend out of a side face of each winding of the at least two windings 231, 232, . . . , and 23n, which can more reduce cutting of the windings by a leakage magnetic field that is generated by magnetic flux leakage in air, thereby more reduce an eddy current loss in the windings.

According to this embodiment of the present application, the two opposite magnet yokes extend out of the at least two windings in two opposite directions.

FIG. 2B is a sectional view along A-A of the coupled inductor shown in FIG. 2A. FIG. 2B is a sectional view of the coupled inductor 200 shown in FIG. 2A in a y-z plane.

As shown in FIG. 2B, at least two magnetic cylinders 211, 212, . . . , and 21n of the coupled inductor 200 are disposed between the upper magnet yoke 221 and the lower magnet yoke 222, and the at least two windings 231, 232, . . . , and 23n are respectively wound around the at least two magnetic cylinders 211, 212, . . . , and 21n.

In the y direction, the right side faces of the upper magnet yoke 221 and the lower magnet yoke 222 extend out of the right side face of the winding 23n. In the reverse direction of the y direction, the left side faces of the upper magnet yoke 221 and the lower magnet yoke 222 extend out of the left side face of the winding 231. A normal direction of the right side faces is the same as the reverse direction of the y direction, and a normal direction of the left side faces is the same as the y direction. In this way, there are fewer opportunities that a leakage magnetic field that is generated by magnetic flux leakage in air cuts the windings 231 and 23n of the inductor. Therefore, an eddy current loss caused by cutting of winding coils of the inductor by the leakage magnetic field can be greatly reduced.

FIG. 2C is a sectional view along B-B of the coupled inductor shown in FIG. 2A. A coupled inductor 200 shown in FIG. 2C is a sectional view of the coupled inductor 200 shown in FIG. 2A in an x-z plane.

As shown in FIG. 2C, any magnetic cylinder 21i of the at least two magnetic cylinders of the coupled inductor 200 is disposed between the upper magnet yoke 221 and the lower magnet yoke 222, and one winding 23i of the at least two windings is wound around the magnetic cylinder 21i. A value of i ranges from 1 to n, and n is an integer greater than or equal to 2.

In the x direction, left side faces of the upper magnet yoke 221 and the lower magnet yoke 222 extend out of a left side face of the winding 23i, and in the reverse direction of the x direction, right side faces of the upper magnet yoke 221 and the lower magnet yoke 222 extend out of a right side face of the winding 23i. A leakage magnetic field that is generated by magnetic flux leakage in air may not cut the winding 23i of the inductor. Therefore, an eddy current loss caused by cutting of winding coils of the inductor by the leakage magnetic field can be greatly reduced.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

FIG. 2D is a sectional view along C-C of the coupled inductor shown in FIG. 2A. A coupled inductor 200 shown in FIG. 2D is a sectional view of the coupled inductor 200 shown in FIG. 2A in an x-y plane.

According to this embodiment of the present application, the two opposite magnet yokes extend out of the at least two windings in four directions in which every two directions are opposite.

As shown in FIG. 2D, the at least two magnetic cylinders 211, 212, . . . , and 21n of the coupled inductor 200 are disposed between the upper magnet yoke (not shown) and the lower magnet yoke 222, and the at least two windings 231, 232, . . . , and 23n are respectively wound around the at least two magnetic cylinders 211, 212, . . . , and 21n.

In the x direction, the front side faces of the upper magnet yoke (not shown) and the lower magnet yoke 222 extend out of the front side face of each winding of the at least two windings 231, 232, . . . , and 23n. In the reverse direction of the x direction, the rear side faces of the upper magnet yoke (not shown) and the lower magnet yoke 222 extend out of the rear side face of each winding of the at least two windings 231, 232, . . . , and 23n.

In the y direction, the right side faces of the upper magnet yoke (not shown) and the lower magnet yoke 222 extend out of the right side face of the winding 23n, and in the reverse direction of the y direction, the left side faces of the upper magnet yoke (not shown) and the lower magnet yoke 222 extend out of the left side face of the winding 231.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

For ease of description of this embodiment of the present application, the technical solution in this embodiment of the present application is described in detail by using a coupled inductor having three magnetic cylinders as an example, but this embodiment of the present application is not limited to this.

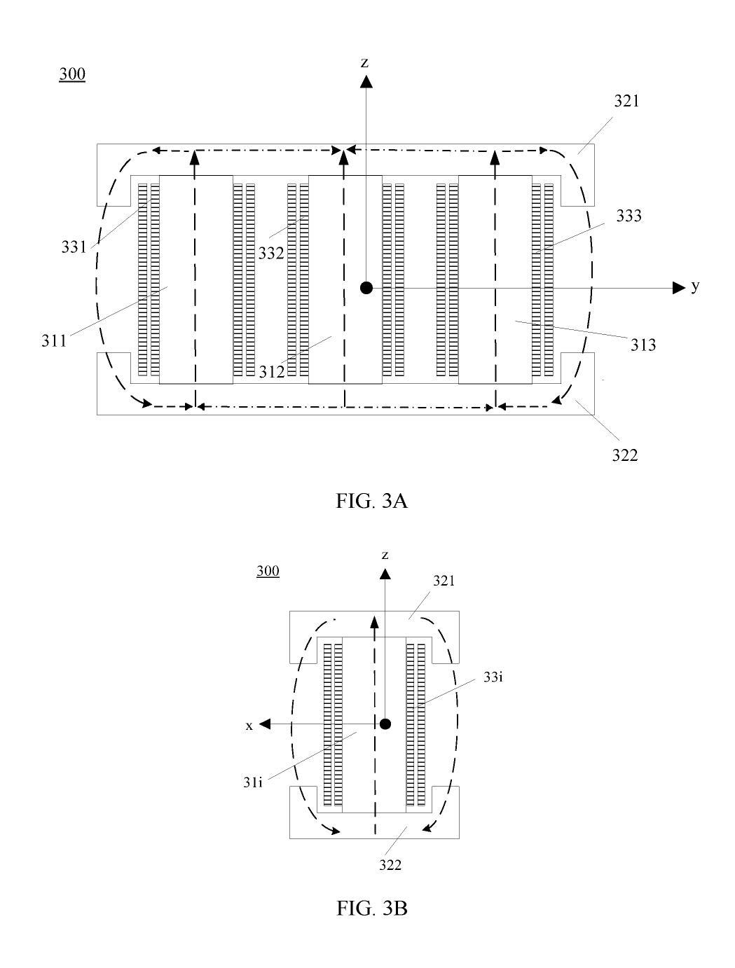

FIG. 3A is a sectional view of a coupled inductor 300 according to another embodiment of the present application. A coupled inductor 300 shown in FIG. 3A is a sectional view of the coupled inductor 300 in an x-z plane.

According to this embodiment of the present application, each magnet yoke of two opposite magnet yokes includes an angle portion, and the angle portion surrounds a part of each of at least two windings.

As shown in FIG. 3A, the coupled inductor 300 includes magnetic cylinders 311, 312, and 313, an upper magnet yoke 321, a lower magnet yoke 322, and windings 331, 332, and 333 respectively wound around the magnetic cylinders 311, 312, and 313. The magnetic cylinders 311, 312, and 313 are disposed between the upper magnet yoke 321 and the lower magnet yoke 322.

After extending out of a right side face of the winding 333 in a y direction, the upper magnet yoke 321 forms an angle portion in a reverse direction of a z direction and the angle portion surrounds an upper-end part of the right side face of the winding 333. After extending out of the right side face of the winding 333 in the y direction, the upper magnet yoke 321 and the lower magnet yoke 322 form an angle portion in a z direction and the angle portion surrounds a lower-end part of the right side face of the winding 333.

After extending out of a left side face of the winding 331 in a reverse direction of the y direction, the upper magnet yoke 321 forms an angle portion and the angle portion surrounds an upper-end part of the left side face of the winding 331 in a reverse direction of the z direction. After extending out of the left side face of the winding 331 in the reverse direction of the y direction, the upper magnet yoke 321 and the lower magnet yoke 322 form an angle portion and the angle portion surrounds a lower-end part of the left side face of the winding 331 in the z direction.

FIG. 3B is another sectional view of a coupled inductor 300 according to another embodiment of the present application. A coupled inductor 300 shown in FIG. 3B is a sectional view of the coupled inductor 300 in an x-z plane.

As shown in FIG. 3B, the coupled inductor 300 includes a magnetic cylinder 31i, an upper magnet yoke 321, a lower magnet yoke 322, and a winding 33i wound around the magnetic cylinder 31i. The magnetic cylinder 31i is disposed between the upper magnet yoke 321 and the lower magnet yoke 322, and i ranges from 1 to 3.

After extending out of a side face of each winding of the winding 33i in an x direction, the upper magnet yoke 321 forms an angle portion in a reverse direction of a z direction and the angle portion surrounds an upper-end part of a side face of each winding of the winding 33i. After extending out a side face of each winding of the winding 33i in the x direction, the lower magnet yoke 322 forms an angle portion in the z direction and the angle portion surrounds a lower-end part of a side face of each winding of the winding 33i.

After extending out of a left side face of the winding 33i in the x direction, the upper magnet yoke 321 forms an angle portion in the reverse direction of the z direction and the angle portion surrounds an upper-end part of the left side face of the winding 33i. After extending out of a right side face of the winding 33i in the reverse direction of the x direction, the upper magnet yoke 321 forms an angle portion in the reverse direction of the z direction and the angle portion surrounds an upper-end part of the right side face of the winding 33i. After extending out of the left side face of the winding 33i in the x direction, the lower magnet yoke 322 forms an angle portion in the z direction and the angle portion surrounds a lower-end part of the left side face of the winding 33i. After extending out of the right side face of the winding 33i in the reverse direction of the x direction, the lower magnet yoke 322 forms an angle portion in the z direction and the angle portion surrounds a lower-end part of the right side face of the winding 33i.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

It should be understood that, after extending out of four side faces of the windings 331, 332, and 333 in the x direction, the reverse direction of the x direction, the y direction, and the reverse direction of the y direction, the upper magnet yoke 321 and the lower magnet yoke 322 included in the coupled inductor 300 may further form angle portions in the z direction and the reverse direction of the z direction. The angle portions surround a part of the six side faces of the windings 331, 332, and 333 so that cutting of winding coils of an inductor by a leakage magnetic field can be more reduced and an eddy current loss caused when a magnetic field cuts the winding coils of the inductor can be more reduced, thereby improving efficiency of a system with a small load.

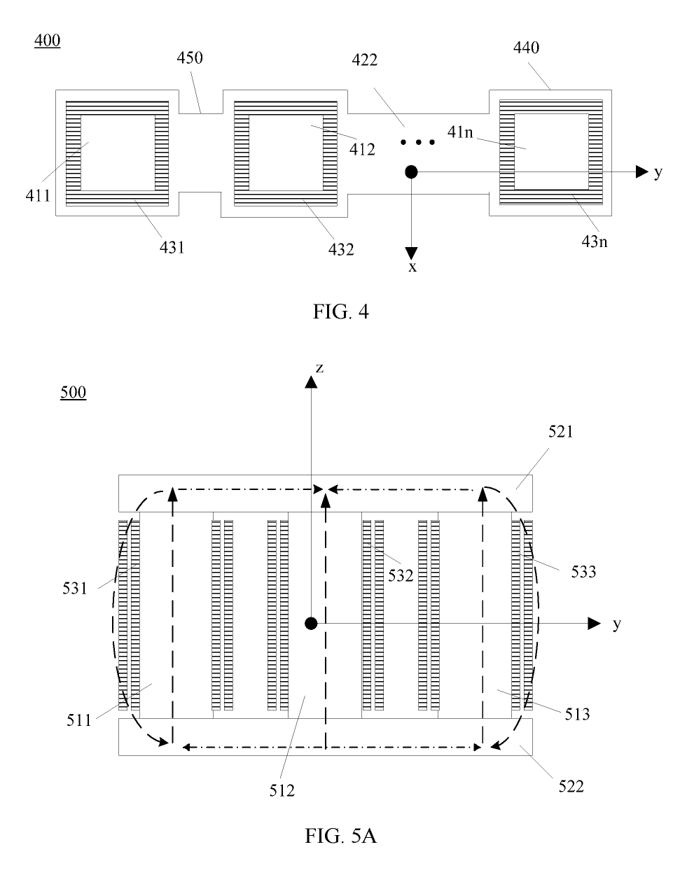

FIG. 4 is a sectional view of a coupled inductor 400 according to another embodiment of the present application. A coupled inductor 400 shown in FIG. 4 is a sectional view of the coupled inductor 400 in an x-y plane.

According to this embodiment of the present application, each magnet yoke of two opposite magnet yokes includes at least two first parts corresponding to at least two magnetic cylinders and at least one second part between the at least two first parts, and the at least two first parts each have a width greater than a width of the at least one second part.

As shown in FIG. 4, at least two magnetic cylinders 411, 412, . . . , and 41n of the coupled inductor 400 are disposed between an upper magnet yoke (not shown) and a lower magnet yoke 422, and at least two windings 431, 432, . . . , and 43n are respectively wound around the at least two magnetic cylinders 411, 412, . . . , and 41n. The upper magnet yoke (not shown) and the lower magnet yoke 422 separately include n first parts 440 and n−1 second parts 450. Each second part 450 is located between two first parts 440, and in an x direction, the first parts 440 each have a width greater than a width of the second parts 450. n is an integer greater than or equal to 2.

In other words, side faces of the first parts 440 may be aligned with side faces of the windings or may extend out of side faces of the at least two windings.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved. Moreover, because only the first parts, which correspond to magnetic cylinders, of the magnet yokes are extended, costs of the coupled inductor can be reduced.

It should be understood that, according to this embodiment of the present application, in the x direction, the first parts 440 each may have a width greater than the width of the second part 450, which can also reduce cutting of winding coils of an inductor by a leakage magnetic field to an extent, thereby reducing an eddy current loss caused by the cutting of the winding coils of the inductor by the leakage magnetic field.

It should be further understood that, according to this embodiment of the present application, a magnet yoke may include an angle portion and the angle portion surrounds a lower-end part or upper-end part of a winding.

Optionally, in another embodiment of the present application, at least two windings are aligned with two opposite magnet yokes in at least one direction. In other words, side faces of the two opposite magnet yokes are aligned with side faces of the at least two windings in one or more of the x direction, a y direction, a reverse direction of the x direction, or a reverse direction of the y direction.

For example, in the y direction, a right side face of a winding 43n is aligned with right side faces of the upper magnet yoke (not shown) and the lower magnet yoke 422, or in the reverse direction of the y direction, a left side face of the winding 431 is aligned with left side faces of the upper magnet yoke (not shown) and the lower magnet yoke 422, which can reduce cutting of windings by a leakage magnetic field that is generated by magnetic flux leakage in air, thereby reducing an eddy current loss in the windings.

For ease of description of this embodiment of the present application, the technical solution in this embodiment of the present application is described in detail by using a coupled inductor having three magnetic cylinders as an example, but this embodiment of the present application is not limited to this.

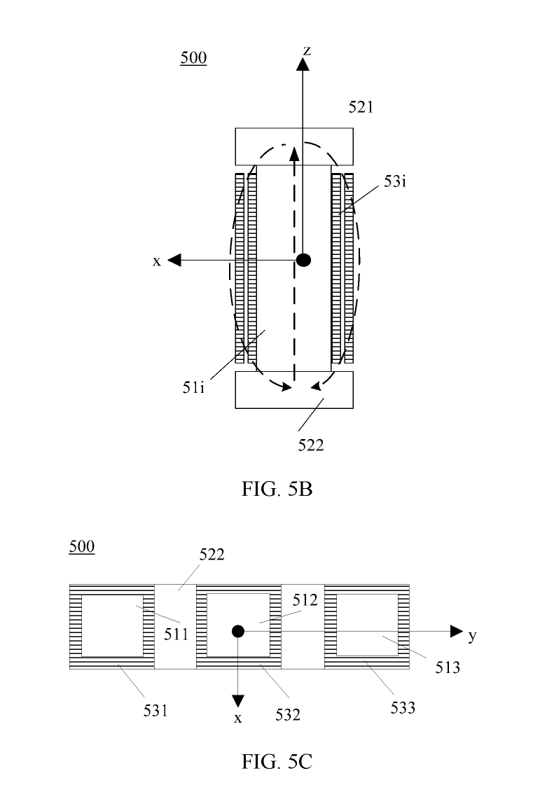

FIG. 5A is a sectional view of a coupled inductor 500 according to another embodiment of the present application. A coupled inductor 500 shown in FIG. 5A is a sectional view of the coupled inductor 500 in a y-z plane.

In this embodiment, two opposite magnet yokes are aligned with at least two windings in two opposite directions.

As shown in FIG. 5A, the coupled inductor 500 includes magnetic cylinders 511, 512, and 513, an upper magnet yoke 521, a lower magnet yoke 522, and windings 531, 532, and 533 respectively wound around the magnetic cylinders 511, 512, and 513. The magnetic cylinders 511, 512, and 515 are disposed between the upper magnet yoke 521 and the lower magnet yoke 522.

In a y direction, right side faces of the upper magnet yoke 521 and the lower magnet yoke 522 are aligned with a right side face of the winding 533, and in a reverse direction of the y direction, left side faces of the upper magnet yoke 521 and the lower magnet yoke 522 are aligned with a left side face of a winding 531. In this way, cutting of windings of an inductor by a leakage magnetic field that is generated by magnetic flux leakage in air can be reduced, thereby reducing an eddy current loss caused by cutting of winding coils of the inductor by the leakage magnetic field.

FIG. 5B is another sectional view of a coupled inductor 500 according to another embodiment of the present application. A coupled inductor 500 shown in FIG. 5B is a sectional view of the coupled inductor 500 in an x-z plane.

As shown in FIG. 5B, the coupled inductor 500 includes a magnetic cylinder 51i, an upper magnet yoke 521, a lower magnet yoke 522, and a windings 53i wound around the magnetic cylinder 51i. The magnetic cylinder 51i is disposed between the upper magnet yoke 521 and the lower magnet yoke 522, and i ranges from 1 to 3.

In an x direction, front side faces of the upper magnet yoke 521 and the lower magnet yoke 522 are aligned with a front side face of the winding 53i, and in a reverse direction of the x direction, rear side faces of the upper magnet yoke 521 and the lower magnet yoke 522 are aligned with a rear side face of the winding 53i. In this way, cutting of windings of an inductor by a leakage magnetic field that is generated by magnetic flux leakage in air can be reduced, thereby reducing an eddy current loss caused by cutting of winding coils of the inductor by the leakage magnetic field.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

FIG. 5C is still another sectional view of a coupled inductor 500 according to an embodiment of the present application. A coupled inductor 500 shown in FIG. 5C is a sectional view of the coupled inductor 500 in an x-y plane.

According to this embodiment of the present application, two opposite magnet yokes are aligned with at least two windings in four directions in which every two directions are opposite.

As shown in FIG. 5C, the coupled inductor 500 includes three magnetic cylinders 511, 512, and 513 that are disposed between an upper magnet yoke (not shown) and a lower magnet yoke 522, and the three windings 531, 532, and 533 are respectively wound around the three magnetic cylinders 511, 512, and 513.

In an x direction, front side faces of the upper magnet yoke (not shown) and the lower magnet yoke 522 are aligned with a front side face of each winding of the three windings 531,532, and 533, and in a reverse direction of the x direction, rear side faces of the upper magnet yoke (not shown) and the lower magnet yoke 522 are aligned with a rear side face of each winding of the three windings 531, 532, and 533.

In a y direction, right side faces of the upper magnet yoke (not shown) and the lower magnet yoke 522 are aligned with a right side face of the winding 533, and in a reverse direction of the y direction, left side faces of the upper magnet yoke (not shown) and the lower magnet yoke 522 are aligned with a left side face of the winding 531.

According to this embodiment of the present application, the magnet yokes may be extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

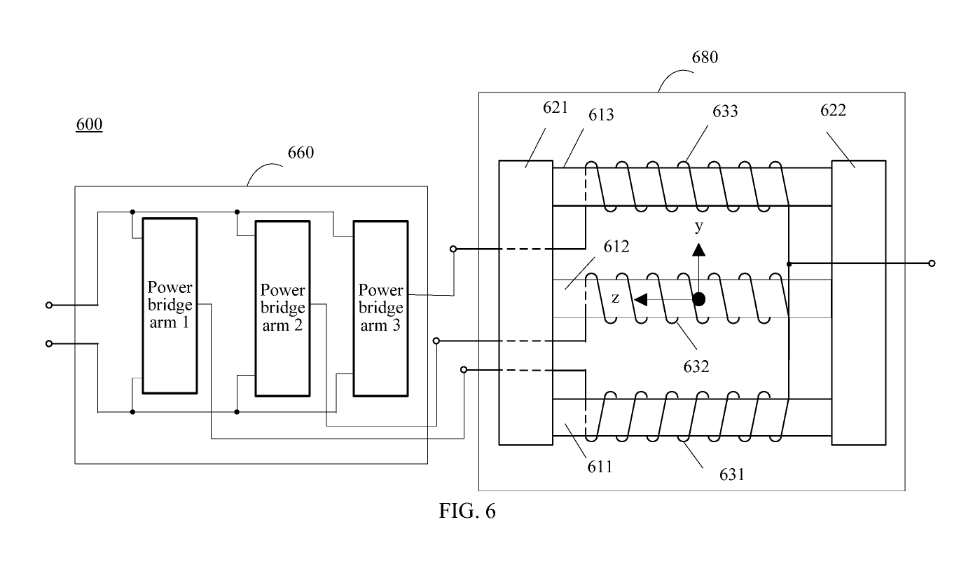

FIG. 6 is a schematic structural diagram of a power converter 600 according to an embodiment of the present application. The power converter 600 includes at least two power bridge arms and the coupled inductor described in the foregoing embodiments. At least two windings of the coupled inductor are respectively connected to the at least two power bridge arms.

A description is provided by using three power bridge arms 660, and this embodiment of the present application is not limited to this. The coupled inductor in this embodiment of the present application may be connected to multiple power bridge arms, and each power bridge arm corresponds to one input end of the coupled inductor.

The power converter 600 shown in FIG. 6 includes three power bridge arms 660 and a coupled inductor 680.

A structure of the coupled inductor 680 is like the coupled inductor 500 shown in FIG. 5A in the foregoing embodiments of the coupled inductor, and a detailed description is appropriately omitted herein. Output ends of the three power bridge arms 660 are respectively connected to input ends of three windings 631, 632, and 633 included in the coupled inductor 680.

Input ends of a power bridge arm 1, a power bridge arm 2, and a power bridge arm 3 are connected in parallel between the two input ends of the power converter 600. An output end of the power bridge arm 1 is connected to an input end of the winding 631 of the coupled inductor. An output end of the power bridge arm 2 is connected to an input end of the winding 632 of the coupled inductor. An output end of the power bridge arm 3 is connected to an input end of the winding 633 of the coupled inductor. Output ends of the windings 631, 632, and 633 are coupled together and connected to an output end of the power converter 600. The coupled inductor 680 includes first magnetic cylinders 611, 612, and 613, an upper magnet yoke 621, a lower magnet yoke 622, and the three windings 631, 632, and 633. The first magnetic cylinders 611, 612, and 613 are disposed between the upper magnet yoke 621 and the lower magnet yoke 622, and two side faces, left side faces and right side faces of the upper magnet yoke 621 and the lower magnet yoke 622, are respectively aligned with a left side face of the winding 631 and a right side face of the winding 633 or extend out of a left side face of the winding 631 and a right side face of the winding 633. The three windings 631, 632, and 633 are respectively wound around the three magnetic cylinders 611, 612, and 613.

Therefore, the magnet yokes of the power converter in this embodiment of the present application are extended in at least one direction so that the at least two windings do not extend out of the magnet yokes in at least one direction, which can reduce cutting of the windings of the coupled inductor by a leakage magnetic field, thereby reducing an eddy current loss caused by the windings of the coupled inductor. In addition, when a load of the power converter at which the coupled inductor is located is relatively small, efficiency of the power converter can also be obviously improved.

The present application is described in detail with reference to the accompany drawings and in combination with the exemplary embodiments, but the present application is not limited thereto. Various equivalent modifications or replacements can be made to the embodiments of the present application by a person of ordinary skill in the art without departing from the spirit and essence of the present application, and the modifications or replacements shall fall within the scope of the present application.

What is claimed is:

1. A coupled inductor comprising:
a magnetic core comprising:
at least two magnetic cylinders; and
two opposite magnet yokes,
wherein the at least two magnetic cylinders are disposed between the two opposite magnet yokes; and
at least two windings respectively wound around the at least two magnetic cylinders,
wherein the at least two windings are in a one-to-one correspondence with the at least two magnetic cylinders,
wherein the at least two windings do not extend out of the two opposite magnet yokes in at least one direction, and
wherein each direction of the at least one direction is a direction perpendicular to axes of the at least two magnetic cylinders.

2. The coupled inductor according to claim 1, wherein the two opposite magnet yokes extend out of the at least two windings in the at least one direction.

3. The coupled inductor according to claim 2, wherein the two opposite magnet yokes extend out of the at least two windings in two opposite directions.

4. The coupled inductor according to claim 2, wherein the two opposite magnet yokes extend out of the at least two windings in four directions including a pair of directions that are opposite.

5. The coupled inductor according to claim 1, wherein each magnet yoke of the two opposite magnet yokes comprises an angle portion, and wherein the angle portion surrounds a part of each of the at least two windings.

6. The coupled inductor according to claim 1, wherein each magnet yoke of the two opposite magnet yokes comprises at least two first parts corresponding to the at least two magnetic cylinders and at least one second part between the at least two first parts, and wherein the at least two first parts each have a width greater than a width of the at least one second part.

7. The coupled inductor according to claim 1, wherein the at least two windings are aligned with the two opposite magnet yokes in at least one direction.

8. The coupled inductor according to claim 7, wherein the two opposite magnet yokes are aligned with the at least two windings in two opposite directions.

9. The coupled inductor according to claim 7, wherein the two opposite magnet yokes are aligned with the at least two windings in four directions in which every two directions are opposite.

10. The coupled inductor according to claim 1, wherein the at least two magnetic cylinders comprise two magnetic cylinders or three magnetic cylinders.

11. A power converter comprising:
at least two power bridge arms; and
a coupled inductor comprising:
a magnetic core, comprising:
at least two magnetic cylinders; and
two opposite magnet yokes,
wherein the at least two magnetic cylinders are disposed between the two opposite magnet yokes; and
at least two windings respectively wound around the at least two magnetic cylinders,
wherein the at least two windings are in a one-to-one correspondence with the at least two magnetic cylinders,
wherein the at least two windings do not extend out of the two opposite magnet yokes in at least one direction,
wherein each direction of the at least one direction is a direction perpendicular to axes of the at least two magnetic cylinders, and
wherein the at least two power bridge arms are respectively connected to at least two windings of the coupled inductor.

12. The power converter according to claim 11, wherein the two opposite magnet yokes extend out of the at least two windings in the at least one direction.

13. The power converter according to claim 12, wherein the two opposite magnet yokes extend out of the at least two windings in two opposite directions.

14. The power converter according to claim 12, wherein the two opposite magnet yokes extend out of the at least two windings in four directions including a pair of directions that are opposite.

15. The power converter according to claim 12, wherein each magnet yoke of the two opposite magnet yokes comprises an angle portion, and wherein the angle portion surrounds a part of each of the at least two windings.

16. The power converter according to claim 15, wherein each magnet yoke of the two opposite magnet yokes comprises at least two first parts corresponding to the at least two magnetic cylinders and at least one second part between the at least two first parts, and wherein the at least two first parts each have a width greater than a width of the at least one second part.

17. The power converter according to claim 13, wherein the at least two windings are aligned with the two opposite magnet yokes in at least one direction.

18. The power converter according to claim 17, wherein the two opposite magnet yokes are aligned with the at least two windings in two opposite directions.

19. The power converter according to claim 17, wherein the two opposite magnet yokes are aligned with the at least two windings in four directions in which every two directions are opposite.

20. The power converter according to claim 4, wherein the at least two magnetic cylinders comprise two magnetic cylinders or three magnetic cylinders.
